(19) United States
(12) Patent Application Publication
(10) Pub. No.: US 2017/0164056 A1
(43) Pub. Date: Jun. 8, 2017

(54) ANNOTATION METHOD AND CORRESPONDING DEVICE, COMPUTER PROGRAM PRODUCT AND STORAGE MEDIUM

(71) Applicant: THOMSON LICENSING, Issy les Moulineaux (FR)

(72) Inventors: Joel SIROT, Montreuil sur llle (FR); Jean-Ronan VIGOUROUX, Rennes (FR); Louis CHEVALLIER, LA MEZIERE (FR)

(21) Appl. No.: 15/322,113

(22) PCT Filed: Jun. 23, 2015
(86) PCT No.: PCT/EP2015/064159

§ 371 Date: Dec. 25, 2016

(30) Foreign Application Priority Data
Jun. 25, 2014 (FR) 1455918

(51) Int. Cl. H04N 21/4725; G06F 17/30; H04N 21/435; H04N 21/858; H04N 21/414; H04N 21/845

(52) U.S. Cl. CPC H04N 21/4725; H04N 21/41407; H04N 21/8456; H04N 21/435; H04N 21/8583; G06F 17/3082; G06F 17/30268; G06F 17/3079

(57) ABSTRACT

The present disclosure relates to a method for annotating a content element of a video stream which has been at least partially received by an electronic device, said method being implemented by said electronic device during a restitution of said video stream. According to the present disclosure, the method comprises:—receiving at least one item of information for identifying an image part in said video stream, comprising a temporal and/or spatial stamping of said image part;—when said identified image part belongs to a portion already restituted of said video stream: analysing said restituted portion, and obtaining a significant content element from said identified image part; searching for the presence of said significant content element in an image, called marked image, of at least one portion remaining to be restituted of said video stream; when a marked image is found, associating an annotation linked to said content item with a marked image; when no marked image is found, restituting said identified image again, while delivering at least one annotation linked to said content element.

### 1. FIELD OF THE PRESENT DISCLOSURE

The field of the present disclosure relates to the sharing of indications relating to an item of content broadcast to several devices.

An annotation method, a computer program product, a storage medium and a corresponding electronic device are described.

### 2. PRIOR ART

Users like sharing comments related about multimedia contents like videos. Document US2014/0196082 discloses a comment information generating apparatus that includes a comment input receiving unit which receives position information of an object in a video and a comment displayed with the object.

However, users viewing at the same time a same item of content from several devices can have difficulty sharing their impressions of this item of content due to the time-lag which can exist between the restitution of the two items of content. Such a time-lag can for example be due to the different network paths used for routing the item of content from a broadcasting source, for example a common broadcasting source, to the two devices. It can also be due to other factors, notably to different distances of certain devices with respect to the broadcasting source, or to the processing capabilities of the devices or of certain intermediary devices (such as routers or network repeaters) involved in the transmission of the content between the broadcasting source and each of the two devices. Moreover, the reaction time of each of the users and the fluctuating nature of the content of a video stream (a particular element sometimes appearing only very momentarily in a video stream) can also make more difficult the sharing of an element considered interesting by a user with a second user viewing the same content.

### 3. SUMMARY

The present disclosure makes it possible to improve the situation by proposing a method making it possible, in at least one embodiment, to share an annotation linked to a particular element of a video stream more easily and in a more suitable way than the solutions of the prior art.

More specifically, the present disclosure relates to a method for annotating a content element of a video stream which has been at least partially received by an electronic device, for example a video stream being received or already received by the electronic device, said method being implemented by said electronic device during a restitution of said video stream.

According to the present disclosure, the annotation method comprises:
receiving at least one item of information for identifying at least one image part in said video stream, comprising a temporal and/or spatial stamping of said at least one image part;
when said identified image part belongs to a portion already restituted of said video stream:
   analysing said portion already restituted, and obtaining at least one significant content element from said identified image part;
   searching for the presence of said significant content element in at least one image, called marked image, of at least one portion remaining to be restituted of said video stream;
   when at least one marked image is found, associating at least one annotation linked to said content item with at least one of said marked images.
   when no marked image is found in at least one portion remaining to be restituted of said video stream, restituting said identified image again, while delivering at least one annotation linked to said content element.

In particular, according to a particular embodiment, the annotation method comprises a storage in a buffer memory of at least one portion already received of said video stream; and said portions already restituted and remaining to be restituted belong to said stored portion.

According to a particular embodiment, said search is limited to the images belonging to a stream portion following said identified image in said video stream.

According to a particular embodiment, said search excludes the images of said video stream already restituted by said electronic device.

According to a particular embodiment, said method comprises, when at least one marked image is found, restituting at least one stream portion comprising at least one of said marked images while delivering said associated annotation.

According to a particular embodiment, when at least one marked image is found, delivering said associated annotation comprises restituting said identified image again.

According to a particular embodiment, said annotation is obtained during said receiving.

According to a particular embodiment, said annotation belongs to the group comprising:
a graphical designation of at least one image part;
a textual element;
an audio element;
an additional image;
an additional video sequence.

According to a particular embodiment, said search comprises a tracking of said content element in a stream portion following said identified image in said video stream.

According to a particular embodiment, said analysis and/or said search implements a shape recognition technique.

Although not explicitly described, the embodiments presented can be implemented using any combination or sub-combination. For example, an embodiment wherein the reception comprises an obtaining of an annotation can be combined with an embodiment wherein the analysis implements a shape recognition technique and where the search excludes the images of said video stream already restituted by said electronic device.

Other embodiments, easily conceivable by those skilled in the art on reading the present description, are also included within the scope of the present disclosure.

In particular, the present disclosure applies to the annotation of a video stream being received, the restitution of the annotated stream being carried out in real time or in a deferred manner, or to the annotation of a video stream already received whose restitution is carried out as the annotation takes place, and/or in a deferred manner.

According to another aspect, the present disclosure relates to an electronic device, comprising at least one processor configured to annotate a content element of a video stream which has been at least partially received during a restitution of said video stream.

According to the present disclosure, said at least one processor is configured for:
receiving at least one item of information for identifying at least one image part in said video stream comprising a temporal and/or spatial stamping of said at least one image part;
when said identified image part belongs to a portion already restituted of said video stream:
   analysing said portion already restituted, and obtaining at least one significant content element from said identified image part;
   searching for the presence of said significant content element in at least one image, called marked image, of at least one portion remaining to be restituted of said video stream;
   when at least one marked image is found, associating at least one annotation linked to said content item with at least one of said marked images;
   when no marked image is found in at least one portion remaining to be restituted of said video stream, restituting said identified image again, while delivering at least one annotation linked to said content element.

According to at least one embodiment, said at least one processor is configured for storing in a buffer memory at least one portion already received of said video stream and said portions already restituted and remaining to be restituted belong to said stored portion.

According to another aspect, the present disclosure relates to a computer program product. According to the present disclosure, such a computer program product comprises program code instructions for executing the above annotation method, in any one of the aforementioned embodiments, when said program is executed by a computer.

According to another aspect, the present disclosure relates to a computer-readable storage medium on which is saved a computer program comprising program code instructions for executing the above annotation method, in any one of the aforementioned embodiments, when said program is executed by a computer.

Such a computer-readable storage medium can take the form of a computer program product loaded onto at least one computer-readable storage medium comprising computer-readable and computer-executable program code instructions.

Thus, in the present patent application, a computer-readable storage medium is considered as being a non-transitory storage medium having the intrinsic capacity to store information and the intrinsic capacity to enable a restitution of the items of information which it stores.

A computer-readable storage medium can be for example, but not only, a system, a device or an item of equipment which is electronic, magnetic, optical, electromagnetic or infra-red, made of semiconductors or implements a combination of the techniques previously mentioned. It should be underlined that the following elements, which provide more specific examples of computer-readable storage media to which the principles of the present disclosure can be applied, are essentially mentioned for illustrative purposes and in no case constitute an exhaustive list, as will be easily interpreted by those skilled in the art: a portable computer diskette, a hardware disc, a memory of ROM (Read Only Memory) type, an erasable memory of EPROM (Erasable Programmable Read Only Memory) type or flash memory, a portable compact disc comprising a ROM memory (CD ROM), an item of optical storage equipment, an item of magnetic storage equipment, or any suitable combination of the preceding elements.

As would be easily understandable for those skilled in the art, the aspects of the present disclosure can be implemented by a terminal, a server, a computer program product, or a computer-readable storage medium. Thus, aspects of the present disclosure can be implemented in certain embodiments in the form of entirely hardware components (for example an electronic component or an electronic card equipped with components), or in the form of entirely software components (including for example firmware components, a “resident” software program, microcode, etc.). Other embodiments can implement both hardware components and software components. In the present document, the term “module” will generally designate a component which can correspond either to a hardware component or to a software component. Moreover, aspects of the present disclosure can be implemented in the form of a computer-readable storage medium. Any combination of one or more computer-readable storage media can be used.

Thus, at least some of the embodiments of the present disclosure can give a user the option of benefiting from the annotations, made by another user, on particular elements present in an item of video content, notably an item of content which they are both viewing, despite the time-lags between the two streams viewed by the two users.

Moreover, at least some of the embodiments of the present disclosure propose a solution which is easy to implement for a user who does not have special technical skills, with standard-usage communication means (such as a smartphone or a tablet for example).

Moreover, at least some of the embodiments of the present disclosure propose a solution which is not costly in terms of network load, or memory usage, since only the designation information, and not image parts, are transmitted between the two devices, in addition to the complementary annotations.

### 4. LIST OF FIGURES

The present disclosure will be better understood, and other specific features and advantages will emerge upon reading the following detailed description, relating to a particular embodiment, the description making reference to the annexed drawings wherein:

FIG. 1 shows the general principle of the present disclosure, in a particular embodiment;

FIG. 2 is a functional diagram showing the annotation method of the present disclosure, in a particular embodiment;

FIG. 3 shows an electronic device implementing a particular embodiment of the present disclosure.

A same element is designated in all the figures by the same reference symbol. The figures shown are for illustrative purposes only and in no case limit the present disclosure to the embodiments shown.

### 5. DESCRIPTION OF EMBODIMENTS

A particular embodiment of the present disclosure is now briefly presented.

In at least some of the embodiments, the present disclosure makes it possible to share an annotation (for example a simple designation, and/or comments), relating to a particular content element (or significant content element) of an image part of a video stream broadcast to a first and a second device.

The image part containing the significant content element, designated for example from the first device, is received, decorrelated from the stream, by the second device. It can for example be transmitted from the first device to one or more destination devices, including the second device. The annotation relating to this content element is used by the second device to enrich at least one image, belonging to the video stream, comprising this content element. In some embodiments, the restitution of the image comprising the content element and of the annotation can be carried out by the second device. In other embodiments, the restitution can be carried out on a third-party device, from a stream annotated by the second device, for example a media server, using the method of the present disclosure, and transmitted to the third-party device.

A non-negligible time can be necessary to identify, choose and/or annotate, from the first device, a content element of the broadcast stream. Moreover, the time for transmission of at least one item of information making it possible to identify this content element and any complementary annotations to the second device must also be taken into account. So, the broadcast image in which a content element has been designated will in general already have been received or even processed by the second device, during the reception of the identification information, and any complementary annotations, by the second device. It can for example already have been restituted and/or have been stored for a subsequent transmission or restitution. So, according to the present disclosure, the annotation linked to the content element can be displayed during the restitution of an image different from the image in which the content element has been designated, notably another image also containing the content element.

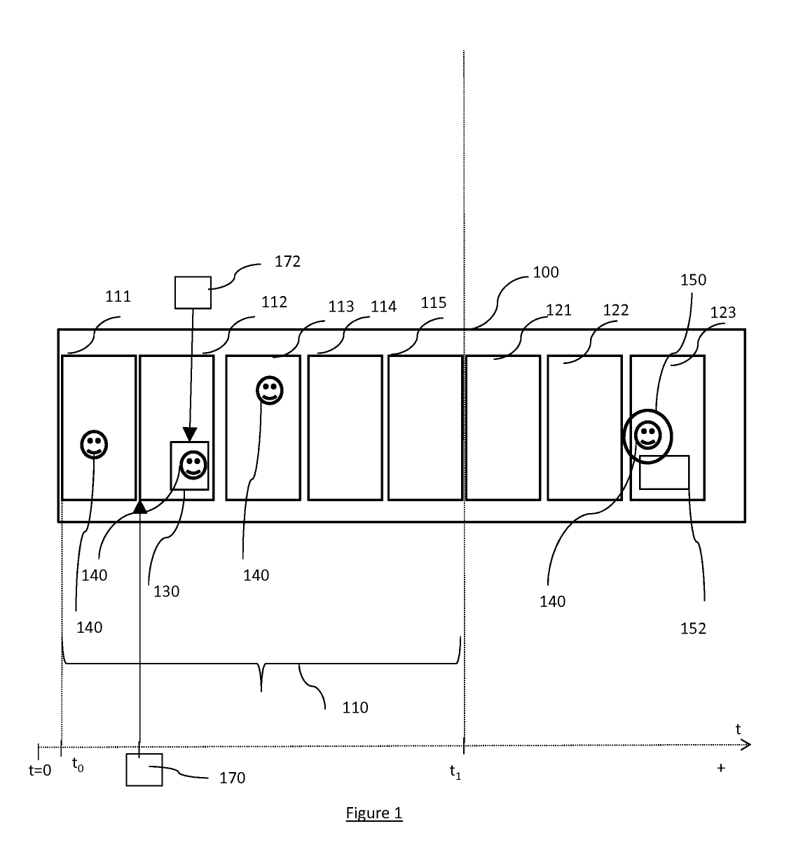

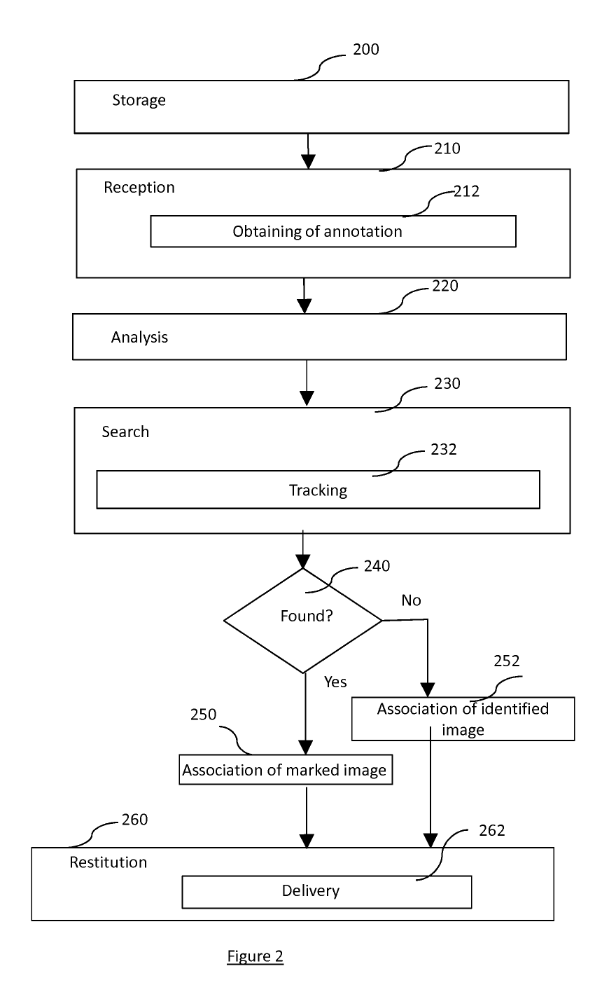

In relation to FIGS. 1 and 2, a particular embodiment of the present disclosure is now presented, in which the stream is broadcast almost simultaneously to a first and second device, for example from a broadcasting source (for example a broadcasting source for a TV programme), and restituted on both these devices. In the embodiment shown, the second device receives in addition to the broadcast stream, an identification of an image part from the first device (for example an annotation made by a user of the first device during the viewing of the video stream on the first device).

In the embodiment shown, the second device is a video restitution device connected to a communication network receiving a video stream. According to the embodiments, this can be a video stream at least a portion of which is still to be received (as in the embodiment shown), or a video stream already received in its entirety, but at least a portion of which is still to be restituted by the video restitution device. Such a video restitution device can for example be a television, a video screen, a set-top box, a personal computer, for example a laptop PC, or another terminal (for example a mobile terminal) connected to a communication network, such as smart glasses (such as the glasses marketed by Google®), a smartphone, or a tablet. Thus, in an embodiment where two users each equipped with a tablet are each viewing a same item of multimedia content, the present disclosure can enable a user to view an annotation made by the other user, in relation to the multimedia content viewed, as shown in FIG. 1.

In some other embodiments, the second device is a media server, which receives a video stream which can be subsequently transmitted, after annotation according to one of the embodiments of the annotation method of the present disclosure, to a third-party device, for example a video restitution device. This can be in particular a server, equipped with large storage capacities, which then transmits the stream or certain portions of the stream (images or video sequence), and annotations (designations, comments, etc.) linked to significant content elements to a third-party device, notably a video restitution device.

FIG. 1 shows a portion 100 of a stream received by the second device. The stream comprises a plurality of images (111, 112, 113, 114, 115, 121, 122, 123), certain images (111, 112, 113, 114, 115) having already been processed (for example stored and/or restituted depending of the embodiments of the present disclosure) at time t₁ of implementation of the method, others (121, 122, 123), still to be processed at time t₁.

As shown in FIG. 1, the solution proposed by the present disclosure, in at least some embodiments, consists in searching, in an already-processed (for example viewed) portion 110 of the stream received 100 by the second electronic device, for a significant content element 140, designated by a determined region of interest 130, in order to then restitute an annotation (for example a designation 150, on a screen for restituting the stream, of the content element 140, and/or any comments 152, and/or an additional image (for example a close-up of the content element, etc.), when the significant content element 140 is again present in at least one image 123, being processed (for example being restituted) on the second device, of the video stream 100.

The identification of a significant content element 140 in the broadcast stream 100 is for example based on a stamping of its temporal position 170 and/or spatial position 172 in the stream (notably its spatial position 172 in an image 112 of the stream itself defined by its own temporal position 170 in the stream 100).

The significant content element 140 can be associated with a first graphical annotation 150 (for example a square or a circle as shown), intended to highlight the identified region of interest, and/or a second annotation, for example an audio and/or textual annotation 152, an illustration, or an additional image or an additional video sequence.

The first graphical annotation can be defined identically, for all regions of interest, for example by configuring one or other of the devices, or dynamically during the definition of a region of interest by a user of the first device. In such embodiments, its graphical representation is transmitted to the second device. It can consist for example of a brightly-coloured circle, or a pattern customised by a user of the first device, intended to be superimposed on the region of interest when it is restituted on the second device.

The second annotation 152 can for example correspond to an audio and/or textual comment, entered or chosen by a user of the first device, to an additional image or an additional video sequence comprising a close-up highlighting the identified region of interest and/or the significant content element 140.

The second annotation can be entered, acquired or chosen by a user of the first device during the definition of the region of interest, and transmitted to the second device. It can also be a determined annotation automatically associated by the first and/or the second device with a significant content element 140 according to at least one item of metadata associated with the broadcast stream 100 or with one of the images (111, 112, 113, 150) to which the significant content element belongs, for example by means of a database.

According to the embodiments, the second annotation linked to a content element can relate to the significant content element itself (this can be for example a comment describing a character for which the content element is the face) or be linked to it indirectly. For example, when the significant content element is a bottle of cola of a certain brand, the second annotation can consist of an advertising message for a fizzy drink of the same brand, or for an equivalent product of a competing brand.

In relation to FIG. 2, the main steps of the annotation method of the present disclosure, in a particular embodiment, are now presented more specifically.

In the embodiment shown, the method comprises a storage 200 in a buffer memory of the video restitution device of at least one portion 110 already received of said video stream 100, for example the last images received. In the embodiment shown, the sizing of the buffer memory of the device notably makes it possible to retain a portion already restituted of the stream 100. For example, the buffer memory can be sized to retain a stream portion corresponding to several hours of restitution (notably so as to retain all the portions of video stream of a film being restituted).

In the particular embodiment of FIG. 2, the method comprises a reception 210 of at least one item of information for identifying at least one image part of the video stream 100. The item of identification information can notably comprise a time indication (or “timestamp”) 170 relating to a particular image of the stream 100 and a spatial indication 172 relating to a region of interest in this image. The position 170 of the image 112 in the stream 100 can be defined for example by a frame number, by a broadcast duration with respect to a common reference instant (for example the start of the broadcast), by a timestamp based on a common time base (and provided for example by a reference clock), or by a time indication such as a decoding indication (or “DTS” for decoding time indication) or presentation indication (or “PTS” for presentation time indication).

The designated region of interest 130 can be described by spatial limits (for example an abscissa belonging to a particular first interval and an ordinate belonging to a particular second interval), relative to a coordinate system of the image or, as shown in FIG. 1, by a region 130 of determined size from or around a point of interest, defined for example by an abscissa and an ordinate or by an angle and a distance, relative to a coordinate system of the image. Such a point of interest can for example have been previously designated by clicking, using a mouse, by a user of a first device.

In some embodiments, for example when several regions of interest in a same image have been defined, the item of identification information can comprise several spatial indications relating to a same time indication. Such embodiments can offer advantages in terms of network load, and processing time for the search (see search 230 FIG. 2), since a single time indication is transmitted for several regions of interest belonging to a same image. In other embodiments, each definition of a region of interest gives rise to the reception of a time indication and a spatial indication. Such embodiments can offer advantages in terms of simplicity of implementation since the regions of interest can be managed independently by the restitution device.

In the embodiment shown, the reception 210 can also comprise an obtaining 212 of an annotation, for example an annotation made from the first device and transmitted at the same time as the items of information for identifying an image part.

In other embodiments, an annotation linked to a content element can also be obtained by access to a database from the second device or take account of local configuration data at the second device. According to the embodiments, this obtaining can be carried out at different steps of the method (for example after reception, or during associations of images and annotations). Thus, a first graphical annotation, highlighting the content element, can be defined according to configuration data of the second device (so as to have for example a colour suitable for the lighting of the restitution screen) or dynamically (for example with a colour chosen with respect to the predominant colours of the image part where the content element is located), and a second annotation (such as an audio and/or textual comment) can be received from the first device and restituted taking account of configuration parameters (such as the size of the alphanumeric characters of a textual comment or a sound level of an audio comment) of the second device.

In the embodiment shown in FIG. 2, the reception 210 is followed by an analysis 220 of the stream portion stored in the buffer memory, to find the image part 130 (or region of interest) identified by the items of identification information received (170, 172) and identify a significant content element 140 in this identified image part 130. Such a significant content element 140 can for example be extracted from the identified image part by techniques for studying images well known to those skilled in the art. It can involve for example techniques based on colourimetry, or shape recognition techniques, notably face isolation techniques, as shown in FIG. 1.

In the particular case shown, the annotation method then comprises a search 230 for the presence of the significant content element 140 identified during the analysis step 220 in at least one image (111, 113, 114, 115, 121, 122,123) other than that in which the significant content element has been identified. The significant content element can for example be searched for in an image (111, 113, 114, 115) temporally following or preceding the image 112 in which the significant content element has been identified and which belongs to a stream portion 110 already restituted on the video restitution device. In some embodiments, it can also be searched for in an image 121 being restituted, or in an image (122, 123) not yet restituted (that is to say, when the stream is being restituted as shown in FIG. 1, an image having a time indication greater than the time indication t₁ of the image 121 being restituted).

In some embodiments, the search 230 can be restricted to the images (113, 114, 115, 121, 122, 123) temporally following the identified image 112 in the stream being received, or to a subset of these images, for example a given stream portion. It can also be limited to the images not yet restituted (122, 123), in an embodiment compatible with that shown in FIG. 1, or to the images being restituted or not yet restituted (121, 122, 123), or to a determined number of images not yet restituted or to a determined restitution duration. Such embodiments will in particular be suitable for an implementation on a restitution device and/or a device having a limited buffer memory storage capacity. In other embodiments, the search can also relate to images 111 temporally preceding the identified image 112. Such embodiments can be particularly suitable for an implementation on a device such as a media server, able to store temporarily the whole video stream before a subsequent restitution of the stream on this device or after transmission, for example for restitution, to a third-party device.

Embodiments where the search relates to an image portion preceding that in which the significant content element has been identified can for example make it possible, during the restitution, to announce as soon as possible the appearance of a significant content element, for example to attract the attention of a user before the occurrence of a fleeting event (for example a grimace made by a person whose face constitutes the significant content element), and/or to take into account the time-lag between the occurrence of an event and its signalling by the first user. Like the analysis 220 of the identified image, the search 230 can implement different techniques for studying images, to detect the presence of the significant element 140 in one of the images to which the search 230 relates.

In some embodiments, the search 230 can comprise a tracking 232 of at least one significant content element 140 in a stream portion following and/or preceding the identified image 110 in the video stream 100. Such an embodiment can in fact make it possible to find more easily in the images to which the search relates a content element having a spatial position which is variable according to the images.

Such a tracking can for example be based on shapes previously isolated, notably by a shape recognition technique.

When at least one image (called “marked image”) containing the significant element is found 240, an association 250 is carried out between at least one of the marked images 113, 123, or at least one of the stream portions comprising a marked image, and at least one annotation 152 linked to the content element. The stream portion comprising a marked image can for example be a stream portion of fixed size centred on the marked image or one of the ends of which is (or is close to) the marked image. According to the embodiments, the annotation can be associated with all the marked images or only with some of them.

Thus, in some embodiments, as in the embodiment shown in FIG. 1, the annotation will be associated only with marked images not yet restituted (even if the search also related to images already restituted).

In some embodiments, when no image containing the significant element has been found 240 during the search (for example because the search is limited to a stream portion which does not contain the content element), an association 252 can be carried out between the identified image and the annotation.

In the embodiment shown, the method further comprises an at least partial restitution 260 of the video stream, comprising notably a delivery 262 of the annotation associated with one of the marked and/or identified images.

The delivery 262 of the annotation can differ according to the embodiments. Thus, in some embodiments, the annotation will be delivered during the restitution of each image with which it is associated. In other embodiments, the annotation can be delivered a limited number of times (for example during the next n restitutions of images with which it is associated). In other embodiments, which can be combined with the preceding embodiments, the delivery of the annotation can comprise the restitution, superimposed on the stream or in a specific area of the screen (for example in a top, bottom or side strip), of the image from which the significant content element has been identified, when it belongs to a portion already restituted of the stream and when the content element is associated with no other image not yet restituted.

The delivery 262 can be carried out for the entire restitution of a stream portion associated with the significant content element, or for a determined time, or until an action of the user of the second device (for example an acknowledgement of the annotation).

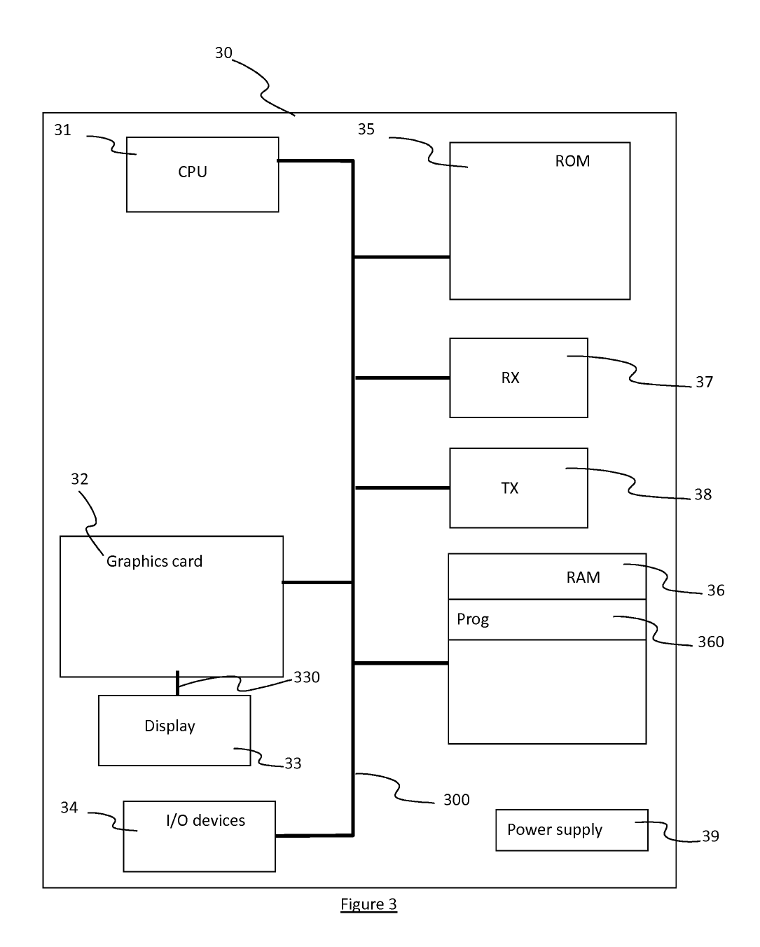

An electronic device suitable for the implementation of the present disclosure, in one of its embodiments, is now presented in FIG. 3 in more detail. According to the embodiments of the present disclosure, it can be a video restitution device, or a media server, temporarily storing a stream received before its subsequent transmission, after annotation according to the method of the present disclosure.

FIG. 3 diagrammatically shows a hardware embodiment of an electronic device 30, suitable for the implementation of the annotation method of the present disclosure, in one of its embodiments.

The electronic device 30 corresponds for example to a laptop, a tablet or a smartphone. It can also be a media server.

In the particular embodiment shown, the electronic device 30 comprises the following modules, connected to each other by an address and data bus 300 which also transports a clock signal:
a microprocessor 31 (or CPU);
a graphics card 32 (optional when the device is a media server);
one or more I/O (Input/Output) devices 34 such as for example a keyboard, a mouse, a webcam, a microphone, a loudspeaker, etc.;
a non-volatile memory of ROM (read only memory) type 35;
a random access memory (RAM) 36;
a communication interface RX 37 configured for the reception of data, for example via a wireless (notably Wifi® or Bluetooth type) connection;
a communication interface 38 configured for the transmission of data, for example via a wireless (notably Wifi® or Bluetooth type) connection;
a power supply 39.

In some embodiments, the electronic device 30 can also comprise or be connected to a display device 33 of display screen type directly connected to the graphics card 32 by a dedicated bus 330. According to a variant, a device for displaying is external to the electronic device 30. In some embodiments, the electronic device can be connected to the display device 33 by wireless communication means. In other embodiments, the electronic device can be connected to the display device 33 by a cable transmitting the display signals. The electronic device 30, for example in the graphics card 32, comprises a means for transmission or connector (not shown in FIG. 3) suitable for transmitting a display signal to an external display means such as for example an LCD or plasma screen or a video projector.

Each of the memories mentioned can comprise at least one “register”, that is to say a memory zone of low capacity (some binary data) or a memory zone of large capacity (making it possible to store a whole programme or all or part of the data representative of data calculated or to be displayed).

When switched on, the microprocessor 31 loads and executes the instructions of the program contained in a register 360 of the RAM 36, and notably the algorithms implementing the steps of the method specific to the present disclosure and described below.

According to a variant, the electronic device 30 comprises several microprocessors.

According to another variant, the power supply 39 is external to the electronic device 30.

In the embodiment shown in FIG. 3, the microprocessor 31 can in particular be configured to annotate a content element of a video stream which has been at least partially received. According to the embodiments, this can be a stream being received by the electronic device or a stream already fully received by the electronic device. In the particular embodiment presented, the processor is configured to:
receiving at least one item of information for identifying at least one image part in said video stream comprising a temporal and/or spatial stamping of said at least one image part;
when said identified image part belongs to a portion already restituted of said video stream:
   analysing said portion already restituted, and obtaining at least one significant content element from said identified image part;
   searching for the presence of said significant content element in at least one image, called marked image, of at least one portion remaining to be restituted of said video stream;
   when at least one marked image is found, associating at least one annotation linked to said content item with at least one of said marked images;
   when no marked image is found in at least one portion remaining to be restituted of said video stream, restituting said identified image again, while delivering at least one annotation linked to said content element.

1. A method for annotating a content element of a video stream which has been at least partially received by an electronic device, said method being implemented by said electronic device during a restitution of said video stream, said method comprising:
receiving at least one item of information comprising a temporal and/or spatial stamping of at least one image part in said video stream;
when said at least one image part belongs to a portion already restituted of said video stream:
obtaining at least one content element of said already restituted portion from said at least one image part;
when said content element is present in at least one image, called marked image, of at least one portion remaining to be restituted of said video stream, associating at least one annotation linked to said content element with at least one of said marked images;
when said content element is not present in at least one portion remaining to be restituted of said video stream, restituting said image part again, while delivering at least one annotation linked to said content element.

2. The method according to claim 1 wherein, when said content element is present in at least one marked image, restituting at least one stream portion comprising at least one of said marked images, while delivering said associated annotation.

3. The method according to claim 2 wherein, when said content element is present in at least one marked image, delivering said associated annotation comprises restituting said image part again.

4. The method according to claim 1 wherein said annotation is obtained during said receiving.

5. The method according to claim 1 wherein said annotation belongs to the group comprising:
a graphical designation of at least one image part;
a textual element;
an audio element;
an image;
a video sequence.

6. The method according to claim 1 further comprising tracking of said content element in a stream portion following said image part in said video stream.

7. The method according to claim 1 wherein said analysis and/or search implements a shape recognition technique.

8. An electronic device, comprising at least one processor configured to annotate a content element of a video stream which has been at least partially received, during a restitution of said video stream, wherein said at least one processor is configured to:
receive at least one item of information comprising a temporal and/or spatial stamping of at least one image part in said video stream;
when said at least one image part belongs to a portion already restituted of said video stream:
obtain at least one content element of said already restituted portion from said at least one image part;
when said content element is present in at least one image, called marked image, of at least one portion remaining to be restituted of said video stream, associate at least one annotation linked to said content element with at least one of said marked images;
when said content element is not present in at least one portion remaining to be restituted of said video stream, restitute said image part again, while delivering at least one annotation linked to said content element.

9. Computer program product, comprising program code instructions for executing the method according to claim 1, when said program is executed by a computer.

10. Computer-readable storage medium on which is saved a computer program comprising program code instructions for executing the method according to claim 1, when said program is executed by a computer.

11. The electronic device according to claim 8 wherein said at least one processor is configured to restitute at least one stream portion comprising at least one of said marked images, while delivering said associated annotation, when said content element is present in at least one marked image.

12. The electronic device according to claim 8 wherein, when said content element is present in at least one marked image, deliver said associated annotation comprises restitute said identified image again.

13. The electronic device according to claim 8 wherein said annotation is obtained during receiving of said at least one item of information.

14. The electronic device according to claim 8 wherein said annotation belongs to the group comprising:
a graphical designation of at least one image part;
a textual element;
an audio element;
an image;
a video sequence.

15. The electronic device according to claim 8 wherein said at least one processor is configured to track said content element in a stream portion following said image part in said video stream.

16. The electronic device according to claim 8 wherein said at least one processor is configured to implement a shape recognition technique.
